(19) United States
(12) Patent Application Publication
(10) Pub. No.: US 2013/0241904 A1
(43) Pub. Date: Sep. 19, 2013

(54) DRIVING CIRCUIT AND DATA TRANSMITTING METHOD THEREOF

(71) Applicant: RAYDIUM SEMICONDUCTOR CORPORATION, Hsinchu (TW)

(72) Inventors: Yu-Lung Lo, Taipei City (TW); Kuan-Hung Chou, Kaohsiung City (TW); Chih-Hsien Jen, Hsinchu City (TW)

(73) Assignee: Raydium Semiconductor Corporation, Hsinchu (TW)

(21) Appl. No.: 13/796,829

(22) Filed: Mar. 12, 2013

(30) Foreign Application Priority Data
Mar. 13, 2012 (TW) 101108487

(51) Int. Cl. G09G 5/00

(52) U.S. Cl. CPC G09G 5/00
USPC 345/204

(57) ABSTRACT

A driving circuit and a data transmitting data method thereof are disclosed. The data transmitting method includes: according to an input control signal, selectively transmitting a plurality digital data to a plurality of channels, wherein the channels include a first channel and a second channel, and the first channel and the second channel respectively have a negative conversion unit and a positive conversion unit; by means of the negative conversion unit or the positive conversion unit converting the digital data into a plurality of negative analog data or a plurality of positive analog data; and according to a switching control signal, by means of a switching unit selectively switching the negative analog data or the positive analog data from its corresponding channel to another channel.

### BACKGROUND OF THE INVENTION

1. Field of the Invention

The present invention relates generally to a driving circuit and a data transmitting method; particularly, the present invention relates to a driving circuit and a data transmitting method used in a display device.

2. Description of the Related Art

The conventional display device includes a front-end circuit and a back-end circuit, wherein the front-end circuit processes digital data, and the back-end circuit converts the digital data into an analog data and transmit the analog data to the panel to display images. Generally, the operation voltage range of the digital data is between 2.5 V and 3.5 V, which is low voltage. However, the operation voltage range of the analog data is between 0 V and 15 V, which is high voltage. In practical applications, the conventional display device utilizes the back-end circuit to convert the digital data.

Please refer to FIG. 1A; FIG. 1A is a schematic view of the back-end circuit of the conventional display device. As shown in FIG. 1A, a back-end circuit 10 includes a low voltage switch 11A, a digital/analog conversion module 12, an operational amplifier 13, a high voltage switch 11B, a first channel CH1, and a second channel CH2, wherein the digital/analog conversion module 12 includes a negative conversion unit 12A and a positive conversion unit 12B which are respectively disposed in the first channel CH1 and the second channel CH2.

It is noted that the operation voltage range of the first digital data D1 and the second digital data D2 is around 3V to 3.3 V, and the first digital data D1 and the second digital data D2 are respectively transmitted in the first channel CH1 and the second channel CH2. In practical applications, the first digital data D1 and the second digital data D2 are respectively transmitted to the digital/analog conversion module 12 by the low voltage switch 11A, and the negative conversion unit 12A and the positive conversion unit 12B respectively convert the first digital data D1 and the second digital data D2 into the first negative analog data D11 and the second positive analog data D22. The operational amplifier 13 respectively operates the first negative analog data D11 and the second positive analog data D22 in the first channel CH1 and the second channel CH2 and outputs the operated data to the high voltage switch 11B.

Please refer to FIG. 1B; FIG. 1B is a schematic view of the back-end circuit of the conventional display device. As shown in FIG. 1B, the first digital data D1 and the second digital data D2 are respectively transmitted in the first channel CH1 and the second channel CH2 and are switched to the second channel CH2 and the first channel CH1 by the low voltage switch 11A. In addition, the second digital data D2 and the first digital data D1 are converted into the second negative analog data D21 and the first positive analog data D12 by the negative conversion unit 12A and the positive conversion unit 12B. It is noted that the second negative analog data D21 and the first positive analog data D12 are respectively transmitted to the operational amplifier 13 for operation. The operated second negative analog data D21 and the first positive analog data D12 are respectively transmitted to the high voltage switch 11B. It is noted that the second negative analog data D21 and the first positive analog data D12 are respectively switched to the second channel CH2 and the first channel CH1 by the high voltage switch 11B.

As shown in FIGS. 1A and 1B, the end of the first channel CH1 has a first negative analog data D11 and a first positive analog data D12, and the end of the second channel CH2 has a second positive analog data D22 and a second negative analog data D21, so that the first channel CH1 and the second channel CH2 can operate the analog data.

In practical applications, when researchers and developers design the back-end circuit 10, the low voltage switch 11A and the high voltage switch 11B have to be disposed in each channel to transmit the digital data or the analog data to the assigned channel. Particularly, the conventional display device utilizes the low voltage switch 11A and the high voltage switch 11B to switch the data respectively, so that each channel can operate corresponding positive analog data and negative analog data. It is desired to decrease the volume and the area of the conventional display device to produce small-size products. However, the low voltage switch 11A and the high voltage switch 11B have fixed volumes; it is hard to decrease the volume of the device effectively.

### SUMMARY OF THE INVENTION

In view of prior arts, the present invention provides a driving circuit and a data transmitting method, which can decrease the cost and the volume effectively.

It is an object of the present invention to provide a data transmitting method, which utilizes different control signals to transmit digital data.

It is an object of the present invention to provide a driving circuit, which utilizes an operational amplifier to switch analog data.

It is an object of the present invention to provide a driving circuit, which decreases the amount of voltage switches to decrease the cost of material.

The present invention provides a driving circuit including a plurality of channels, at least one digital/analog conversion module, and at least one operational amplifier. The channels include a first channel and a second channel, wherein a first digital data and a second digital data are selectively transmitted to the first channel or the second channel according to an input control signal.

In practical applications, each digital/analog conversion module includes a negative conversion unit and a positive conversion unit, and the negative conversion unit and the positive conversion unit are respectively coupled with the first channel and the second channel, so that the first digital data and the second digital data are selectively transmitted to the negative conversion unit or the positive conversion unit to be converted into a negative analog data or a positive analog data; and

In addition, each operational amplifier is coupled with the digital/analog conversion module and has a switching unit, wherein the negative analog data and the positive analog data, according to a switching control signal, are selectively transmitted from the first channel or the second channel to the other channel through the switching unit.

The present invention provides a data transmitting method including: according to an input control signal, selectively transmitting a plurality digital data to a plurality of channels, wherein the channels include a first channel and a second channel, and the first channel and the second channel respectively have a negative conversion unit and a positive conversion unit; by means of the negative conversion unit or the positive conversion unit converting the digital data into a plurality of negative analog data or a plurality of positive analog data; and according to a switching control signal, by means of a switching unit selectively switching the negative analog data or the positive analog data from its corresponding channel to another channel.

In other words, the present invention utilizes the input control signal to control the transmission of the digital data to the first channel or the second channel and to control the transmission of the analog data to the first channel or the second channel by the operational amplifier, further operating the analog data in the first channel and the second channel.

Compared to prior arts, the driving circuit and the data transmitting method of the present invention control the transmission of the digital data to the assigned channel according to the input control signal, utilize the switching unit transmitting the analog data to the original channel or another channel according to the switching control signal to operate the analog data. It is noted that the embodiments of the present invention only utilize the control signals having different control timings and the switching unit to decrease the cost and the area of the chip effectively.

The detailed descriptions and the drawings thereof below provide further understanding about the advantage and the spirit of the present invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic view of the back-end circuit of the conventional display device;

FIG. 1B is a schematic view of the back-end circuit of the conventional display device;

FIG. 2A is a schematic view of the embodiment of the driving circuit in the first control timing of the present invention;

FIG. 2B is a schematic view of the embodiment of the driving circuit in the second control timing of the present invention;

FIG. 3 is a flow chart of the data transmitting method;

FIG. 4A is a flow chart of the data transmitting method for the first digital data of the present invention;

FIG. 4B is a flow chart of the data transmitting method for the second digital data of the present invention; and

FIG. 5 is a flow chart of the data transmitting method of different control timings of the present invention.

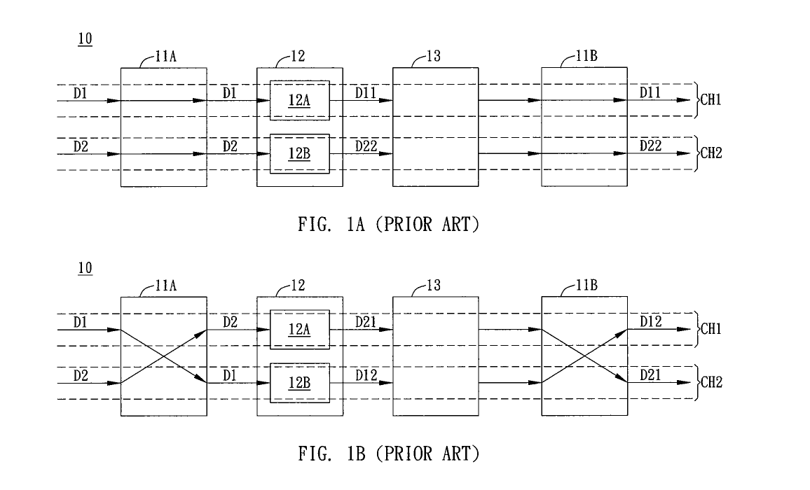

### DETAILED DESCRIPTION

According to an embodiment of the present invention, a driving circuit is provided to control a plurality of digital data. In the embodiment, the driving circuit is used in an LCD device to drive an LCD panel, but is not limited to the embodiment. In other embodiments, the driving circuit can be used in any type of display device, such as plasma display device or laser display device, and is not limited to the embodiment. In practical applications, the driving circuit can be a source driver circuit of the display panel, but is not limited to the embodiment. In the embodiment, the front-end circuit of the display device has a plurality of even number channels and a plurality of odd number channels, wherein the even number channels and the odd number channels are connected with the source driver circuit of the display panel, so that digital data in the channels is switched by the source driver circuit and is converted into analog data. In other words, the driving circuit is the back-end circuit of the display panel and is used to output the analog data to the display panel to output images.

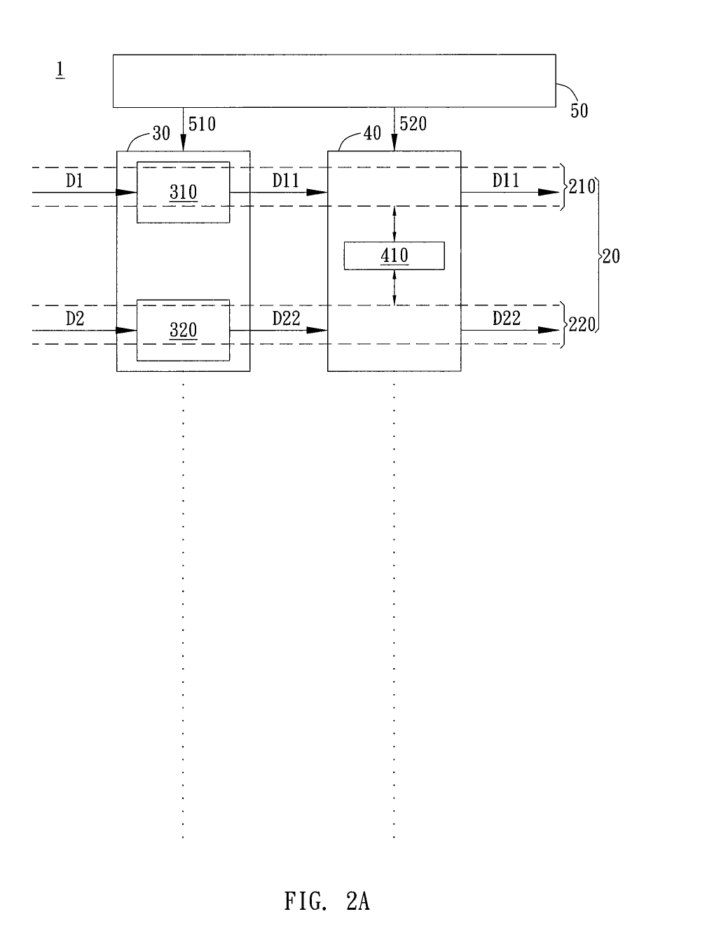

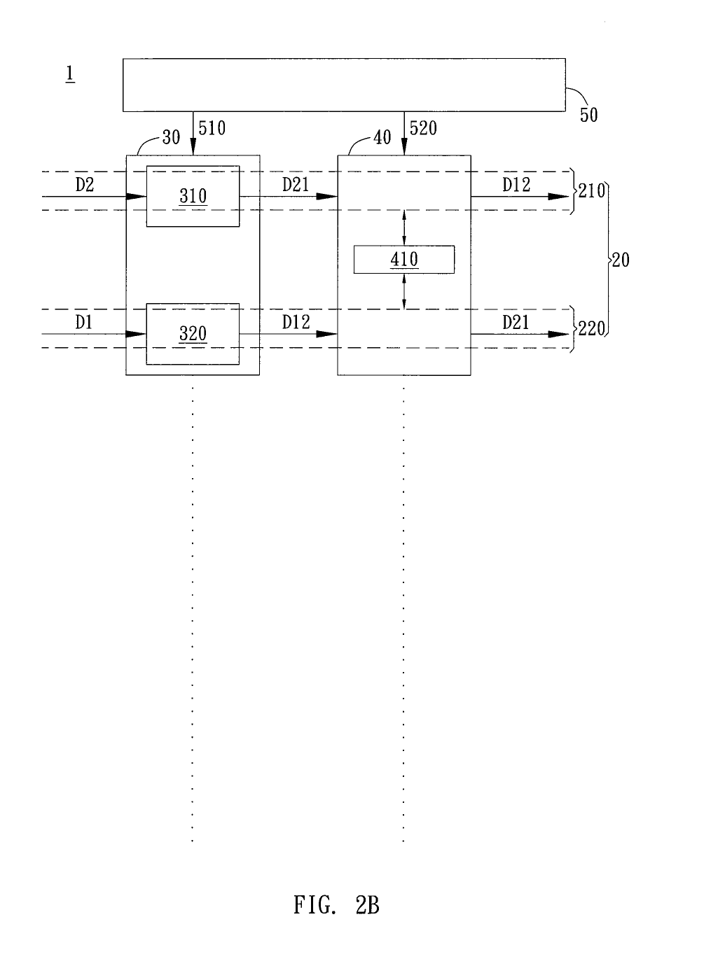

Please refer to FIG. 2A; FIG. 2A is a schematic view of the embodiment of the driving circuit in the first control timing of the present invention. Particularly, FIG. 2A is a schematic view of the driving circuit 1 operating a plurality of digital data in the first control timing. As shown in FIG. 2A, the driving circuit 1 includes a plurality of channels 20, at least one digital/analog conversion module 30, at least one operational amplifier 40, and a control module 50. It is noted that the channels 20 can be any type of channels, and the digital/analog conversion module 30 can be any type of digital/analog converter and not limited to the embodiment. It is noted that the control module 50 generates a plurality of control signals having different control timings, wherein the control signals include an input control signal 510 and a switching control signal 520. In other words, the control module 50 generates the control signals according to the practical use of the circuit 1, but is not limited to the embodiment.

In the embodiment, the channels 20 include a first channel 210 and a second channel 220, wherein a first digital data D1 and a second digital data D2 are selectively transmitted to the first channel 210 or the second channel 220 according to the input control signal 510. As shown in FIG. 2A, each digital/analog conversion module 30 includes a negative conversion unit 310 and a positive conversion unit 320, wherein the negative conversion unit 310 and the positive conversion unit 320 are respectively coupled with the first channel 210 and the second channel 220, so that the first digital data D1 and the second digital data D2 are selectively transmitted to the negative conversion unit 310 or the positive conversion unit 320 to be converted into a negative analog data or a positive analog data.

It is noted that the embodiment utilizes two channels 210/220 and two digital signals D1/D2 to illustrate the present invention, but the amount of channels 20 and the amount of digital data of the driving circuit 1 are not limited to the embodiment. It is noted that the digital data and the analog data are transmitted in the driving circuit 1 in form of voltage, wherein a voltage of the digital data is between 2.5 V and 3.5 V, a voltage of the negative analog data is between 0 V and 7.5 V, and a voltage of the positive analog data is between 7.5 V and 15 V, but not limited to the embodiment. In other words, the negative conversion unit 310 converts the digital data into an analog data with a medium/high voltage; the positive conversion unit 320 converts the digital data into an analog data with a high voltage. In practical applications, low voltage (e.g. 3 V) cannot drive the display panel, so the driving circuit 1 utilizes the medium/high voltage or high voltage (e.g. 7.5 V) to drive the display panel. In the embodiment, the negative conversion unit 310 and the positive conversion unit 320 are level shifters and can convert the voltage of the digital data, but not limited to the embodiment.

In general, the driving circuit 1 transmits the first digital data D1 (or the second digital data D2) in its channel 20 to output the analog data having the medium/high voltage and the analog data having the high voltage, so that the driving circuit 1 operates corresponding analog data in the same channel. As shown in FIG. 2A, each operational amplifier 40 is coupled with the digital/analog conversion module 30 and has a switching unit 410, wherein the negative analog data and the positive analog data, according to a switching control signal 520, are selectively transmitted from the first channel 210 or the second channel 220 to the other channel through the switching unit 520.

For instance, the first digital data D1 is transmitted to the first channel 210 according to a first control timing of the input control signal 510 and is converted to a first negative analog data D11 by the negative conversion unit 310. In addition, please refer to FIG. 2B; FIG. 2B is a schematic view of the embodiment of the driving circuit in the second control timing of the present invention. Particularly, FIG. 2B is a schematic view of the driving circuit 1 operating the digital data in the second control timing. As shown in FIG. 2B, the first digital data D1 is transmitted to the second channel 220 according to the second control timing of the input control signal 510 and is converted into a first positive analog data D12 by the positive conversion unit 320. The first positive analog data D12 is transmitted to the first channel 210 according to the switching control signal 520, so that the first negative analog data D11 and the first positive analog data D12 are operated in the first channel 210. Particularly, the driving circuit 1 compares the first negative analog data D11 with the first positive analog data D12 in the first channel 210 and outputs the compared result to the display panel.

As shown in FIG. 2A, for the second digital data D2, the second digital data D2 is transmitted to the second channel 220 according to the first control timing of the input control signal 510 and is converted into the second positive analog data D22 by the positive conversion unit 320. Please refer to FIG. 2B, the second digital data D2 is transmitted to the first channel 210 according to the second control timing of the input control signal 510 and is converted into the second negative analog data D21 by the negative conversion unit 310. The second negative analog data D21 is transmitted to the second channel 220 according to the switching control signal 520, so that the second negative analog data D21 and the second positive analog data D22 are operated in the second channel 220. Particularly, the driving circuit 1 compares the second negative analog data D21 with the second positive analog data D22 in the second channel 220 and outputs the compared result to the display panel.

Hence, the present invention utilizes the input control signal 510, the switching control signal 520, and the switching unit 410 to switch the digital data and the analog data rather than disposing the low voltage switch and the high voltage switch, further decreasing the cost of material and the area of the chip.

In addition to the embodiment of the driving circuit 1, the present invention provides a data transmitting method to illustrate the practical operation steps.

According to another embodiment of the present invention, a data transmitting method is provided to transmit a plurality of digital data and a plurality of analog data.

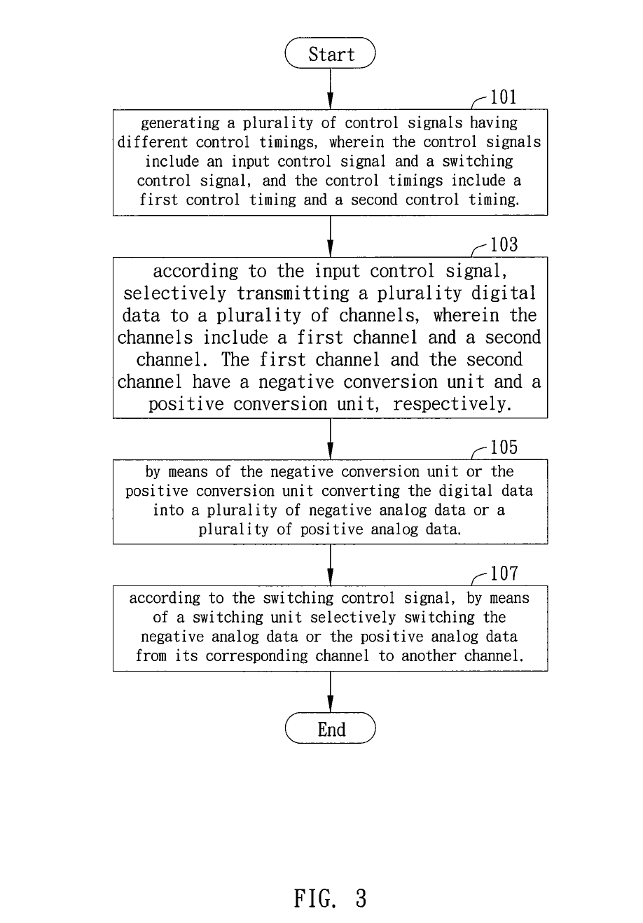

Please refer to FIG. 3; FIG. 3 is a flow chart of the data transmitting method. The data transmitting method includes the step 101: generating a plurality of control signals having different control timings, wherein the control signals include an input control signal and a switching control signal, and the control timings include a first control timing and a second control timing. For instance, as shown in FIGS. 2A and 2B, the control module 50 respectively generates the input control signals 510 having the first control timing and the second control timing and the switching control signal 520.

The step 103 involves according to the input control signal, selectively transmitting a plurality digital data to a plurality of channels, wherein the channels include a first channel and a second channel. The first channel and the second channel have a negative conversion unit and a positive conversion unit, respectively. As shown in FIG. 2A, the first digital data D1 and the second digital data D2 are respectively transmitted to the first channel 210 and the second channel 220 according to input control signal 510. As shown in FIG. 2B, the second digital data D2 and the first digital data D1 are respectively transmitted to the first channel 210 and the second channel 220 according to input control signal 510.

The step 105 includes, by means of the negative conversion unit or the positive conversion unit converting the digital data into a plurality of negative analog data or a plurality of positive analog data. It is noted that a voltage of the digital data is between 2.5 V and 3.5 V, a voltage of the negative analog data is between 0 V and 7.5 V, and a voltage of the positive analog data is between 7.5 V and 15 V, but not limited to the embodiment. For instance, as shown in FIG. 2A, the digital data D1 is converted into the first negative analog data D11 by the negative conversion unit 310; the second digital data D2 is converted into the second positive analog data D22 by the positive conversion unit 320.

The step 107 includes, according to the switching control signal, by means of a switching unit selectively switching the negative analog data or the positive analog data from its corresponding channel to another channel. For instance, as shown in FIG. 2B, the second negative analog data D21 is transmitted from the first channel 210 to the second channel 220 through the switching unit 410 according to the switching control signal 520.

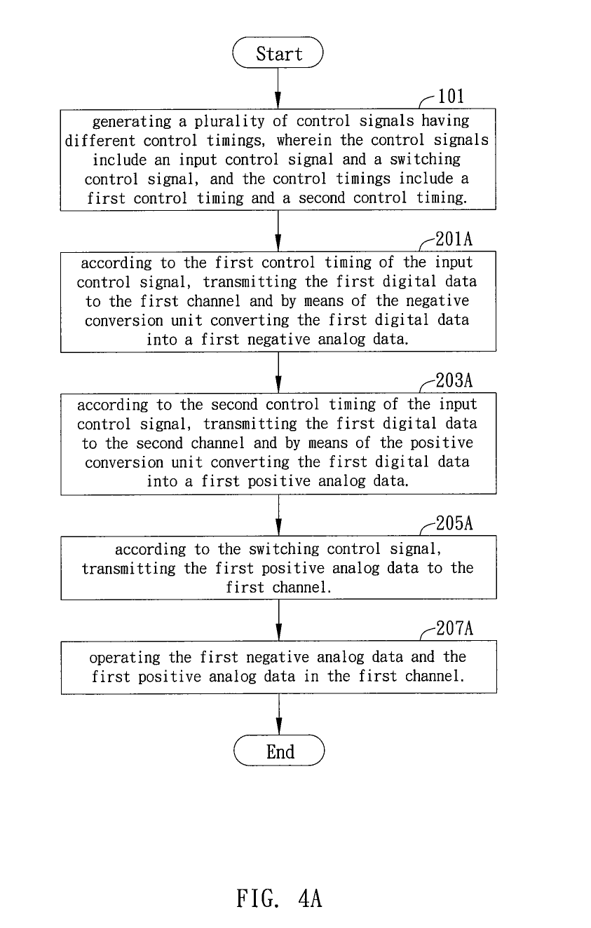

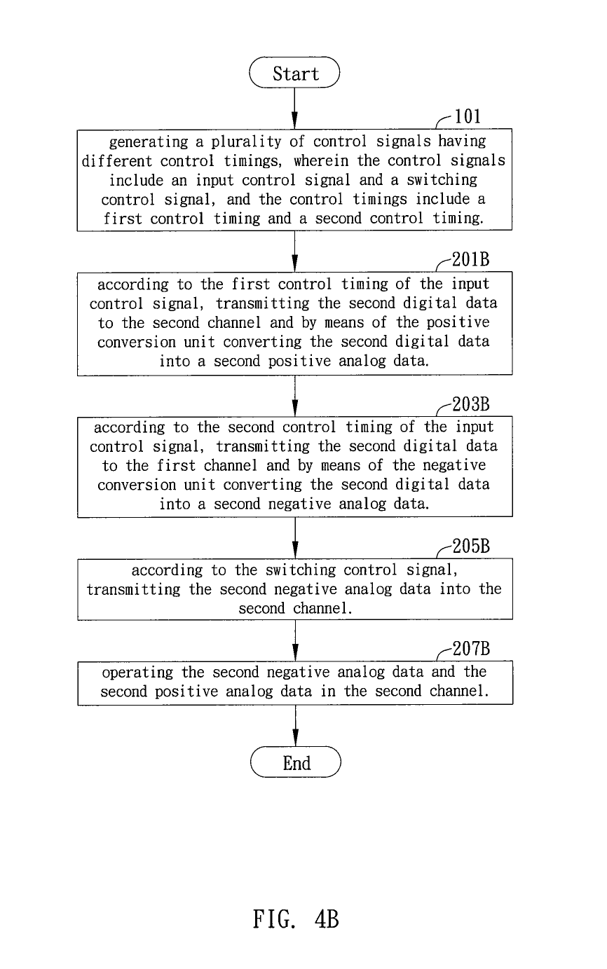

In the embodiment, the digital data of the step 103 in FIG. 3 includes the first digital data and the second digital data. Please refer to FIG. 4A; FIG. 4A is a flow chart of the data transmitting method for the first digital data of the present invention. As shown in FIG. 4A, the method further includes the step 201A: according to the first control timing of the input control signal, transmitting the first digital data to the first channel and by means of the negative conversion unit converting the first digital data into a first negative analog data. The step 203A involves according to the second control timing of the input control signal, transmitting the first digital data to the second channel and by means of the positive conversion unit converting the first digital data into a first positive analog data. The step 205A involves according to the switching control signal, transmitting the first positive analog data to the first channel. The step 207A involves operating the first negative analog data and the first positive analog data in the first channel.

In addition, please refer to FIG. 4B; FIG. 4B is a flow chart of the data transmitting method for the second digital data of the present invention. As shown in FIG. 4B, the method further includes the step 201B, according to the first control timing of the input control signal, transmitting the second digital data to the second channel and by means of the positive conversion unit converting the second digital data into a second positive analog data. The step 203B involves according to the second control timing of the input control signal, transmitting the second digital data to the first channel and by means of the negative conversion unit converting the second digital data into a second negative analog data. The step 205B involves according to the switching control signal, transmitting the second negative analog data into the second channel. The step 207B involves operating the second negative analog data and the second positive analog data in the second channel.

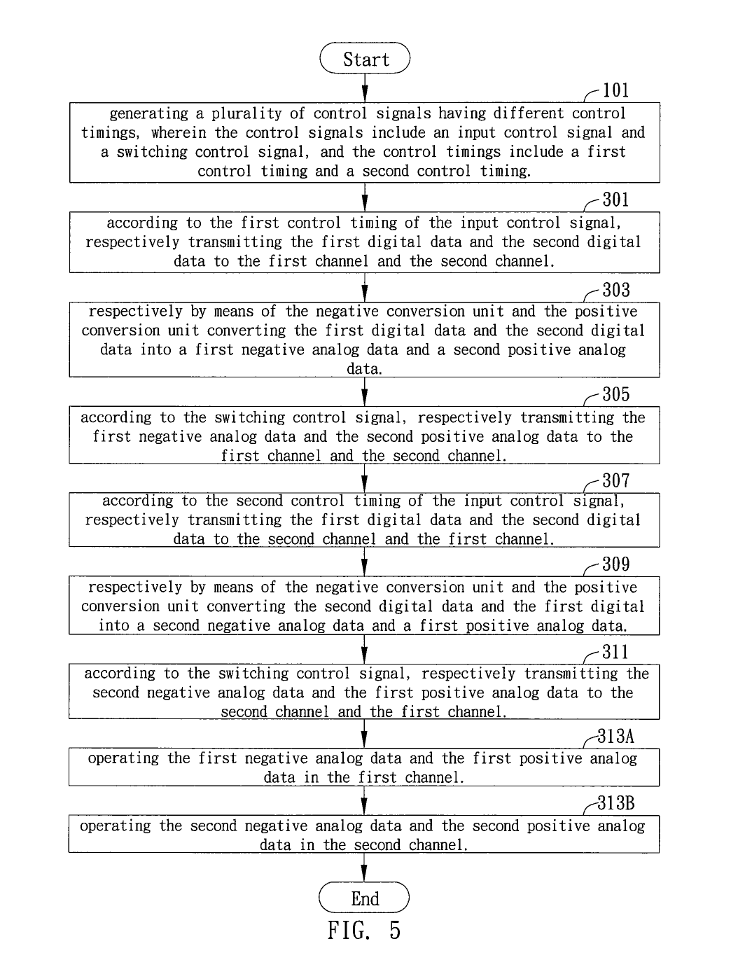

Please refer to FIG. 5; FIG. 5 is a flow chart of the data transmitting method of different control timings of the present invention. As shown in FIG. 5, the method includes the step 301, according to the first control timing of the input control signal, respectively transmitting the first digital data and the second digital data to the first channel and the second channel. The step 303 involves respectively by means of the negative conversion unit and the positive conversion unit converting the first digital data and the second digital data into a first negative analog data and a second positive analog data. The step 305 involves according to the switching control signal, respectively transmitting the first negative analog data and the second positive analog data to the first channel and the second channel. The step 307 involves according to the second control timing of the input control signal, respectively transmitting the first digital data and the second digital data to the second channel and the first channel. The step 309 involves respectively by means of the negative conversion unit and the positive conversion unit converting the second digital data and the first digital into a second negative analog data and a first positive analog data. The step 311 involves according to the switching control signal, respectively transmitting the second negative analog data and the first positive analog data to the second channel and the first channel. The step 313A involves operating the first negative analog data and the first positive analog data in the first channel. The step 313B involves operating the second negative analog data and the second positive analog data in the second channel.

It is noted that, in the flow chart of FIG. 5, the steps 301 to 305 can be executed between the steps 311 and 313. In other words, the steps 301 to 305 are executed according to the first control timing, and the steps 307 to 311 are executed according to the second control timing, wherein the order of the first control timing and the second control timing of the method is not limited to the embodiment.

Compared to prior arts, the driving circuit 1 and the data transmitting method of the present invention control the transmission of the digital data to the assigned channel 20 according to the input control signal 510 and also utilize the switching unit 410 transmitting the analog data to the original channel 20 or the other channel 20 according to the switching control signal 520 to operate the analog data. It is noted that the embodiments of the present invention only utilize the control module generating the control signals having different control timings and the switching unit 410, eliminating the use of low and high voltage switches and further decreasing the cost and the area of the chip.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A data transmitting method, comprising:
(a) according to an input control signal, selectively transmitting a plurality digital data to a plurality of channels, wherein the channels include a first channel and a second channel, and the first channel and the second channel respectively have a negative conversion unit and a positive conversion unit;
(b) by means of the negative conversion unit or the positive conversion unit converting the digital data into a plurality of negative analog data or a plurality of positive analog data; and
(c) according to a switching control signal, by means of a switching unit selectively switching the negative analog data or the positive analog data from its corresponding channel to another channel.

2. The data transmitting method of claim 1, further comprising:
generating a plurality of control signals having different control timings, wherein the control signals comprise the input control signal and the switching control signal, and the control timings comprise a first control timing and a second control timing.

3. The data transmitting method of claim 2, wherein the digital data comprises a first digital data; the data transmitting method comprises:
according to the first control timing of the input control signal, transmitting the first digital data to the first channel and by means of the negative conversion unit converting the first digital data into a first negative analog data;
according to the second control timing of the input control signal, transmitting the first digital data to the second channel and by means of the positive conversion unit converting the first digital data into a first positive analog data;
according to the switching control signal, transmitting the first positive analog data to the first channel; and
operating the first negative analog data and the first positive analog data in the first channel.

4. The data transmitting method of claim 2, where the digital data comprises a second digital data; the data transmitting method comprises:
according to the first control timing of the input control signal, transmitting the second digital data to the second channel and by means of the positive conversion unit converting the second digital data into a second positive analog data;
according to the second control timing of the input control signal, transmitting the second digital data to the first channel and by means of the negative conversion unit converting the second digital data into a second negative analog data;
according to the switching control signal, transmitting the second negative analog data into the second channel; and
operating the second negative analog data and the second positive analog data in the second channel.

5. The data transmitting method of claim 2, wherein the digital data comprises a first digital and a second digital data; the data transmitting method comprises:
according to the first control timing of the input control signal, respectively transmitting the first digital data and the second digital data to the first channel and the second channel;
respectively by means of the negative conversion unit and the positive conversion unit converting the first digital data and the second digital data into a first negative analog data and a second positive analog data; and
according to the switching control signal, respectively transmitting the first negative analog data and the second positive analog data to the first channel and the second channel.

6. The data transmitting method of claim 5, further comprising:
according to the second control timing of the input control signal, respectively transmitting the first digital data and the second digital data to the second channel and the first channel;
respectively by means of the negative conversion unit and the positive conversion unit converting the second digital data and the first digital into a second negative analog data and a first positive analog data; and
according to the switching control signal, respectively transmitting the second negative analog data and the first positive analog data to the second channel and the first channel.

7. The data transmitting method of claim 1, wherein a voltage of the negative analog data is between 0 V and 7.5 V, and a voltage of the positive analog data is between 7.5 V and 15 V.

8. A driving circuit, comprising:
a plurality of channels comprising a first channel and a second channel, wherein a first digital data and a second digital data are selectively transmitted to the first channel or the second channel according to an input control signal;
at least one digital/analog conversion module, wherein each digital/analog conversion module comprises a negative conversion unit and a positive conversion unit, and the negative conversion unit and the positive conversion unit are respectively coupled with the first channel and the second channel, so that the first digital data and the second digital data are selectively transmitted to the negative conversion unit or the positive conversion unit to be converted into a negative analog data or a positive analog data; and
at least one operational amplifier, wherein each operational amplifier is coupled with the digital/analog conversion module and has a switching unit, wherein the negative analog data and the positive analog data, according to a switching control signal, are selectively transmitted from the first channel or the second channel to the other channel through the switching unit.

9. The driving circuit of claim 8, further comprising:
a control module generating a plurality of control signals having different control timings, wherein the control signals comprise the input control signal and the switching control signal.

10. The driving circuit of claim 9, wherein the first digital data is transmitted to the first channel according to a first control timing of the input control signal and is converted to a first negative analog data by the negative conversion unit, and the first digital data is transmitted to the second channel according to a second control timing of the input control signal and is converted into a first positive analog data by the positive conversion unit, the first positive analog data is transmitted to the first channel according to the switching control signal, so that the first negative analog data and the first positive analog data are operated in the first channel.

11. The driving circuit of claim 9, wherein the second digital data is transmitted to the second channel according to a first control timing of the input control signal and is converted to a second positive analog data by the positive conversion unit, and the second digital data is transmitted to the first channel according to a second control timing of the input control signal and is converted into a second negative analog data by the negative conversion unit, the second negative analog data is transmitted to the second channel according to the switching control signal, so that the second negative analog data and the second positive analog data are operated in the second channel.

12. The driving circuit of claim 8, wherein a voltage of the negative analog data is between 0 V and 7.5 V, and a voltage of the positive analog data is between 7.5 V and 15 V.
